(19) United States
(12) Patent Application Publication
(10) Pub. No.: US 2024/0278662 A1
(43) Pub. Date: Aug. 22, 2024

(54) ELECTRIC VEHICLE CHARGING SYSTEM AND ELECTRIC VEHICLE CHARGER-INTEGRATED BUS-PLUG

(71) Applicant: EATON INTELLIGENT POWER LIMITED, DUBLIN 4 (IE)

(72) Inventors: Walter Lawlor, Hodges, SC (US); Saivaraprasad Murahari, Peachtree City, GA (US); Advait Madhusudan Katarki, Altanta, GA (US)

(73) Assignee: EATON INTELLIGENT POWER LIMITED, DUBLIN 4 (IE)

(21) Appl. No.: 18/581,793

(22) Filed: Feb. 20, 2024

Related U.S. Application Data
(60) Provisional application No. 63/447,132, filed on Feb. 21, 2023.

(51) Int. Cl. B60L 53/16; B60L 53/30; H02J 7/00

(52) U.S. Cl. CPC B60L 53/16; B60L 53/30; H02J 7/00304; H02J 7/0047

(57) ABSTRACT

An electric vehicle (EV) charging system includes a first busway connected to a power source, the first busway including a first socket and a first busbar structured to carry current from the power source to the first socket; a first bus-plug structured to be plugged into the first socket, the first bus-plug including a first EV charger structured to charge a first EV of an EV fleet; and a first EV connector that is coupled to the first EV charger via a first EV cord and structured to be inserted into a power receptacle for the first EV.

### CROSS-REFERENCE TO RELATED APPLICATION

This patent application claims the priority benefit under 35 U.S.C. § 119(e) of U.S. Provisional Application No. 63/447,132, filed on Feb. 21, 2023, the contents of which are herein incorporated by reference.

### FIELD OF THE INVENTION

The disclosed concept relates generally to an electric vehicle (EV) charging system and EV charger, and in particular, to an EV charger-integrated bus-plug for use in a busway.

### BACKGROUND OF THE INVENTION

As the world transitions to sustainable and renewable energy, the demand for electric vehicles as well as electric vehicle supply equipment (EVSE) has recently increased significantly. For example, in 2022 EV sales grew by 65% while total new vehicle sales fell 8%. It is forecasted that 1 million or more EVs will be sold in the U.S. in 2023. With the advent of the electric semi-trucks, corporations with needs for transport, storage and/or delivery of their inventories are gradually switching to such large capacity EVs for their commercial fleets. These EV commercial fleets generally start with a small number of EVs, due in part to limited production of such EVs. As the production of these EVs increases and the corporations expand their EV fleets, the corporations will need to scale up their electrical infrastructure to charge their growing EV fleets. Many EV charging installations require heavy labor with a traditional cable and/or conduit installation, rendering the expansion of the EV fleets difficult.

There is room for improvement in EV charging of commercial EV fleets.

### SUMMARY OF THE INVENTION

These needs, and others, are met by an electric vehicle (EV) charging system including a first busway connected to a power source, the first busway including the first socket and a first busbar structured to carry current from the power source to the first socket; a first bus-plug structured to be plugged into the first socket and including a first EV charger structured to charge a first EV of an EV fleet; and a first EV connector coupled to the first EV charger via a first EV cord and structured to be inserted into a power receptacle for the first EV.

Another example embodiment provides a bus-plug for use in a busway for distributing power from a power source to a load. The bus-plug includes an EV charger disposed therein and structured to charge an EV and an adapter structured to fixedly attach the EV charger to the bus-plug.

Yet another example embodiment provides a method for charging an EV fleet. The method includes: providing an EV charging system that comprises a first busway connected to a power source, the first busway including the first socket and a first busbar structured to carry current from the power source to the first socket; a first bus-plug structured to be plugged into the first socket and including a first EV charger structured to charge a first EV of an EV fleet; and a first EV connector coupled to the first EV charger via a first EV cord and structured to be inserted into a power receptacle for the first EV; inserting the first EV connector to the power receptacle for the first EV; and charging, by the first EV charger, the first EV via the first EV connector and the first cord.

### BRIEF DESCRIPTION OF THE DRAWINGS

A full understanding of the invention can be gained from the following description of the preferred embodiments when read in conjunction with the accompanying drawings in which:

FIG. 1 illustrates an EV charging system in accordance with a non-limiting example embodiment of the disclosed concept;

FIGS. 2A-B illustrate an exemplary bus-plug with an EV charger integrated therein in accordance with a non-limiting example embodiment of the disclosed concept;

FIG. 3 is a perspective view of the exemplary bus-plug of FIGS. 1-2B plugged and locked into a tapping point of a busway according to a non-limiting example embodiment of the disclosed concept,

FIG. 4 is a front view of the exemplary bus-plug of FIGS. 1-2B plugged and locked into a tapping point of a busway according to a non-limiting example embodiment of the disclosed concept;

FIGS. 5A-C illustrate an exemplary adapter structured to fixedly attach an EV charger onto an inner surface of a bus-plug in accordance with a non-limiting example embodiment of the disclosed concept; and

FIG. 6 is a flow chart of a method of charging an EV fleet in accordance with a non-limiting example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As the world transitions to sustainable and renewable energy, corporations are switching their commercial fleets to EVs. As the EV fleets expand, it can be difficult to scale up the electrical infrastructure for charging the EV fleets. Many EV charging installations require heavy labor with a traditional cable and/or conduit installation. The example embodiments resolve these problems by providing a scalable EV charging system that includes an EVSE disposed within a bus-plug (e.g., an enclosure with a plug-in capability) structured to be coupled to a socket in a busway. Since a busway is already available for power distribution in a facility, e.g., warehouse, garages for semi-trucks, storages), installing the EVSE within a pluggable enclosure to the busway resolves any space issues on the ground and avoid any injury, loss of inventories, or accidents. Further, a busway is easily expandable as the facility expands by simply adding additional busways and plugging in additional bus-plugs with an EVSE incorporated therein.

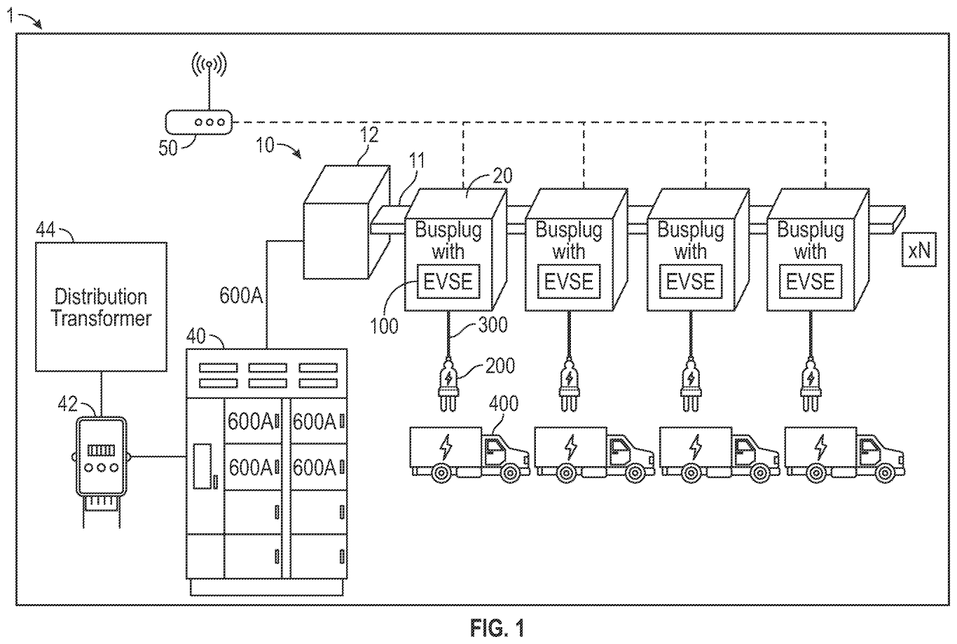

Referring now in detail to the figures, where like reference numerals refer to like parts or components throughout, FIGS. 1-5C show an EV charging system 1 and/or a bus-plug 20 with an EV charger 100 integrated therein in accordance with optional aspects of the disclosed concept. FIG. 1 illustrates an EV charging system 1 in accordance with a non-limiting example embodiment of the disclosed concept. The EV charging system 1 includes a busway 10, a bus-plug 20, an EV charger 100 integrated within the bus-plug 20, an EV connector 200, an EV cord 300, an adapter 30, and a panelboard 40. The EV charging system 1 may be implemented in a large facility, e.g., without limitation, a large parking garage in which one or more EVs of an EV fleet may be parked for charging. Optionally, it may be implemented at a large outdoor parking lot, and in such outdoor parking lot, the busway 10 and the bus-plug 20 as well as the EV connector 200 and EV cord 300 are water-proof and weather-proof.

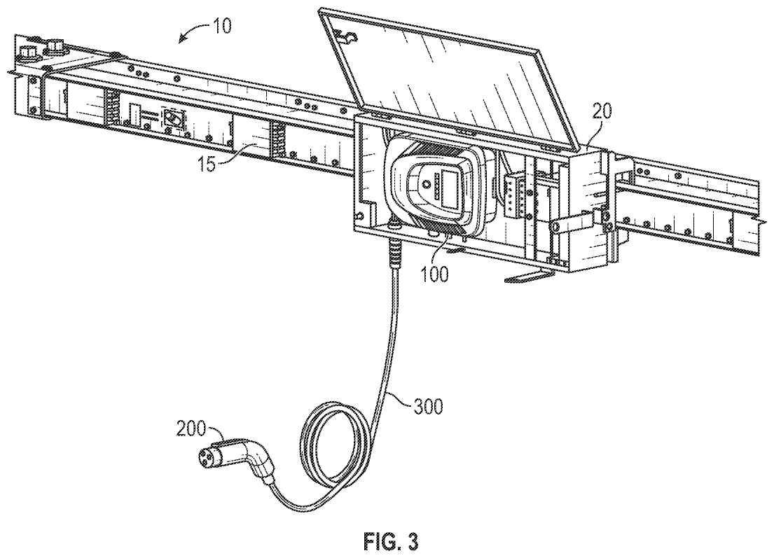

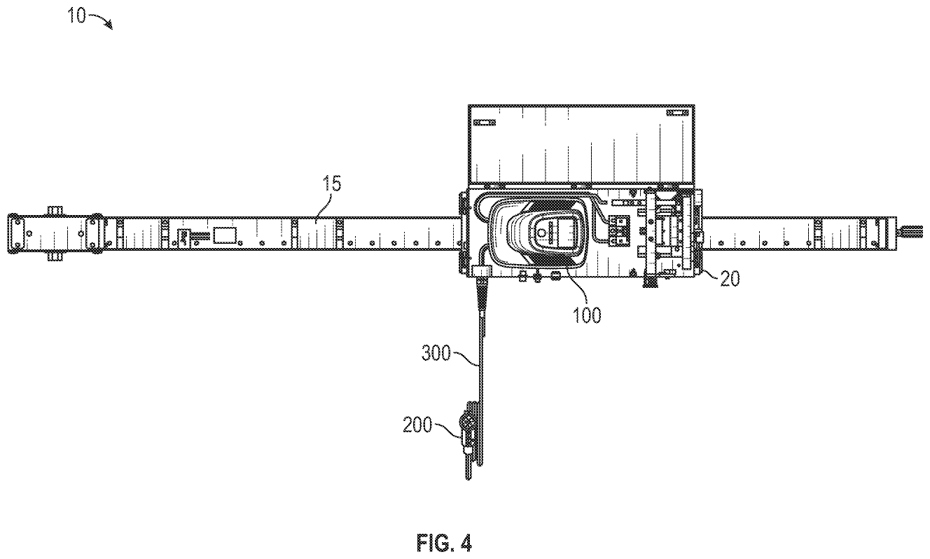

The busway 10 is a prefabricated electrical distribution system including conductive bus bars in a protective enclosure, including straight lengths, fittings, devices and accessories. It is structured to distribute electrical powers to loads (e.g., lighting, equipment, or EVs 400) and is coupled to panel boards 40, switchgear, or transformers. The busway 10 may be disposed on or in proximity (e.g., less than 0.3 meters (1 foot)) to the ceiling of the facility, e.g., without limitation, a parking garage. In the example in which the facility is an outdoor parking lot, the busway 10 is structured to be disposed substantially above the EV 400, e.g., without limitation, at least 1 meter (i.e., 0.91 ft) above the height of the EV 400. It has a housing 11, insulators, fittings 12 and elongated conductive busbars that are disposed within the housing 11 and structured to carry multi-phase high current from a power source 44 to the loads via the panel board 40. The housing 11 may be, e.g., without limitation, an aluminum or steel enclosure structured to enclose the busbars. The busway 10 also includes electrical sockets (e.g., sockets 15 as shown in FIGS. 3-4) disposed along the length of the busway 10 such that a user can tap-off power by plugging the loads into the sockets 15. The busway 10 may comprise a plurality of busways 10 electrically connected or interlocked together in end-to-end relation, and thus provide continuous power to the loads located at various parts of the facility. As such, the EV charging system 1 may be expanded or contracted by adding or removing one or more busways 10 and/or the bus-plugs 20.

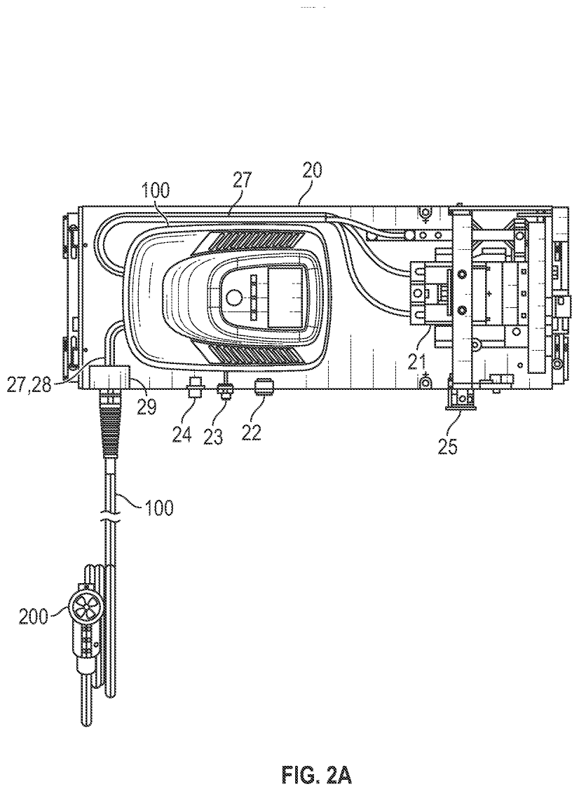

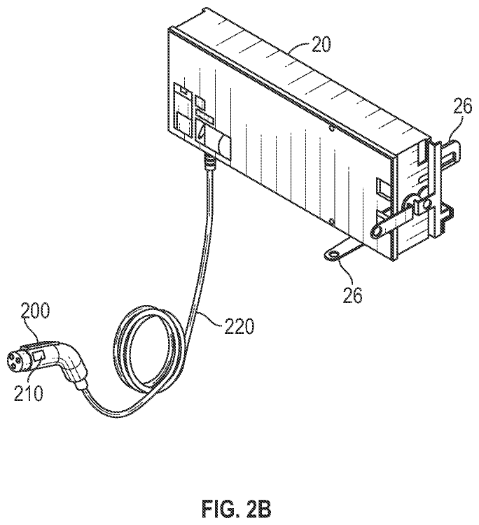

The bus-plug 20 may be a removable enclosure with a plug structured to be plugged into the sockets 15. The bus-plug 20 incorporates an EV charger 100 therein. In some examples, the bus-plug 20 may incorporate a plurality of EV chargers 100 therein. As shown in FIG. 2A, the EV charger 100 is affixed to an inner surface of the bus-plug 20 via the adapter 30. The EV charger 100 may be any EV charger structured to charge an EV 400. That is, the EV charger 100 includes any type of EV chargers, e.g., without limitation, an AC EV charger, a DC EV charger, a Level 1 EV charger, a Level 2 EV charger, etc. The EV charger 100 may provide continuous high current at, e.g., without limitation, 80 A for high rated equipment having high power applications such as EV semi-trucks, cyber trucks, and so forth. The EV charger 100 may be coupled to a current protection device 21 disposed within the bus-plug 20 for circuit protection. The EV charger 100 may be a standard EV smart charger with wired or wireless communication capability with an EV load management system (e.g., without limitation, the EV fleet power workstation, the panel board 14) via a gateway 50 (e.g., without limitation, a gateway edge device). The gateway 50 may provide cellular wireless connectivity to the cloud to and from which the utility or the user may access data (e.g., without limitation, charging, metering, and historical data). The EV charger 100 may be capable of remote-access-control by a user via, e.g., without limitation, RF communications protocols such as Zigbee, Z-Wave, and so forth. The EV charger 100 is connected to the panel board 40 via the busway 10. The EV charger 100 may also include or be coupled to a metering device, which meters the power being expended via the EV charger 100.

The bus-plug 20 may include a current protection device 21, an LED indication light 22, an E-stop field connection 23, an Ethernet port 24 and an ON/OFF control 25. The current protection device 21 is structured to provide overcurrent protection for the EV charger 100 and respective loads. It can be a fuse, a circuit breaker, or any other type of circuit interrupting device. The LED indication light 22 is structured to indicate the status of the EV charger 100, e.g., without limitation, charge status or conditions of the EV charger 100. The E-stop field connection 23 is structured to be coupled to, e.g., without limitation, a stop button on a wall such that the user can push the button and turn off the EV charger 100 in emergency or as necessary as required by local electrical code. Ethernet port 24 is structured to provide a wired connection to a local workstation or computing system for the user to monitor and/or control the EV charger 100, the current protection device 21, and/or the bus-plug 20. The ON/OFF control 25 may be a throttle which can be maneuvered to turn on and off the power supplied to the bus-plug 20. The bus-plug 20 may also include power lines 27 (L1, L2, Neutral) that are coupled to the EV charger 100 and the current protection device 21. The power lines 27 then exit the EV charger 100 coupled to the EV connector 200. Also, low voltage communication lines 28 are coupled to the EV charger 100 and the EV connector 200 for communicating the status and conditions of the EV charger 100.

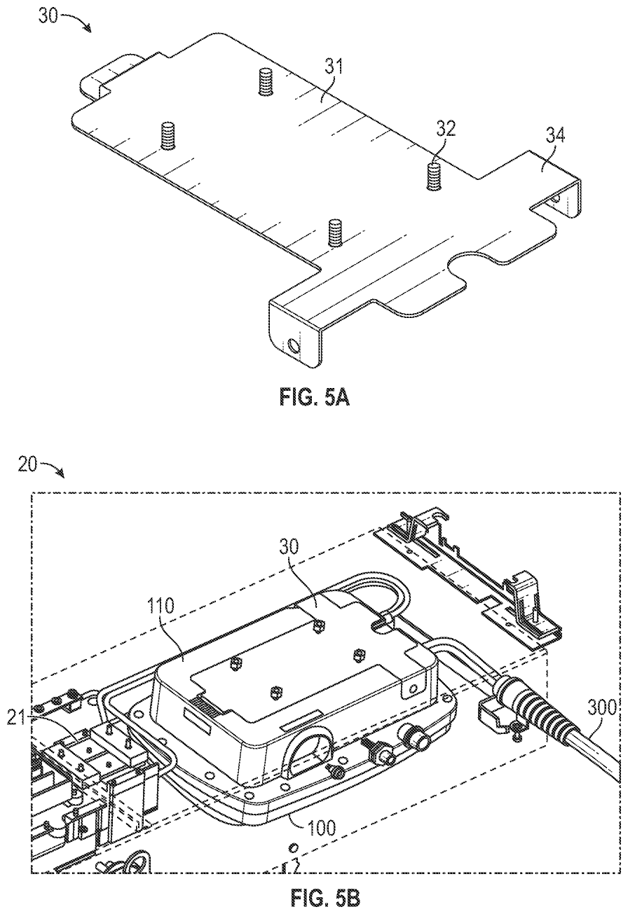

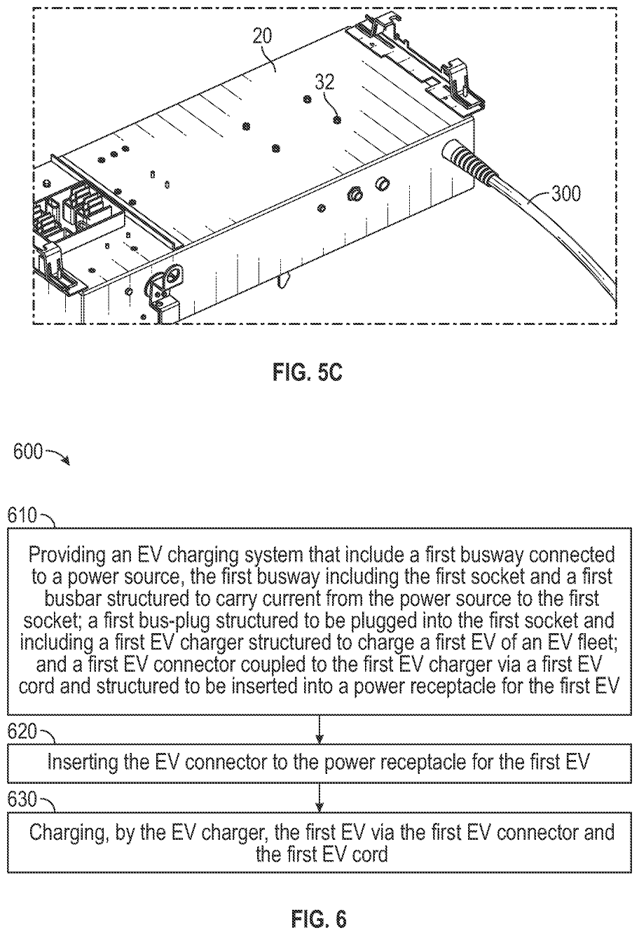

The bus-plug 20 may also include a locking mechanism 26 (e.g., connecting elements 26, as shown in FIG. 2B) structured to solidly lock or affix the bus-plug 20 onto the busway 10. The locking mechanism 26 may be bolted to the housing 11 of the busway 10 via fixing components (e.g., without limitation, bolts, screws, etc.). The bus-plug 20 can be removed or detached from the busway 10 by unplugging from the sockets 15 and/or unfastening the locking mechanism 26. Thus, the bus-plug 20 can be easily replaced, swapped and/or relocated as the user desires. The bus-plug 20 may be of, e.g., without limitation, aluminum or steel. Optionally, it can be made of or coated with water-proof material, e.g., without limitation, thermoset. The bus-plug 20 may include a plurality of thru-holes via which fixing components (e.g., fixing components 32 as shown in FIG. 5A) of the adapter 30 are inserted such that the adapter 30 fixedly attaches the EV charger 100 to the bus-plug 20.

Optionally, the bus-plug 20 may also include a cable management system 29. The cable management system 29 may have a spring loaded mechanism or any other mechanism that allows the EV cord 300 to be expanded or contracted based on a user input (e.g., without limitation, a pull or grip of a user). As such, the cable management system 29 enables the EV cord 300 and the EV connector 200 to be placed at a position (e.g., without limitation, suspended overhead or on a wall) accessible to the user for charging and away from the EV 400 and a drive path of the EV 400. For example, when a user drives an EV 400 into the parking garage, the EV cord 300 and the EV connector 200 are disposed at the position within reach of the user. The user may simply grab the EV connector 200 and pull it to deploy the EV cord 300 to convenient length for the user to connect the EV connector 200 to the EV 400 for charging. When the user is finished with charging, the user releases the EV connector 200. The EV connector 200 and the EV cord 300 will then return to their initial positions out of the way from the EV 400 and the drive path such that the user can drive away the EV 400 without contacting or damaging the EV 400, the EV connector 200 and/or the EV cord 300.

The EV connector 200 is a standard EV connector (e.g., without limitation, SE J1772 connector) structured to be inserted into a power receptacle for the EV 400. Optionally, the EV connector 200 may include a user verification component 210 as shown in FIG. 2B. The optional user verification component 210 may be, e.g., QR code verifier or any other authenticator using, e.g., without limitation, password, user ID, etc. The user can enter or scan a QR code or other authentication code over the verification component 210, the QR code is then communicated to the EV charger 100 and the EV load management system, which verifies the QR or authentication code. Upon verification, the EV charger 100 can start charging the EV 400.

The EV cord 300 is UL compliant multi-wire conductors enclosed within insulating cables for EV charging. It may have maximum length of 7.62 m (i.e., 25 feet).

The adapter 30 is structured to fixedly attach the EV charger 100 to the bus-plug 20. As illustrated in FIGS. 5A-C, the adapter 30 may be a mounting bracket 30 structured to mount the EV charger 100 to the bus-plug 20. The adapter 30 may include a plate 31, a plurality of thru-holes, and a plurality fixing components (e.g., without limitation, screws, bolts 32 as shown in FIG. 5A). The plate 31 is bolted onto a back surface of the EV charger 100 and an inner surface of the back side of the bus-plug 20 via the fixing components 32 and thru-holes. The adapter 30 may also include side brackets 34 that are structured to be affixed to the side surfaces of the housing 110 of the EV charger 100. Thus, the EV charger 100 is firmly held in position within the bus-plug 20. The adapter 30 can be configured to connect, attach or affix any EV charger 100 in any shape or form within the bug-plug 20. It can be easily reconfigured to fit any type of EV chargers 100 to mount them to any bus-plug having various dimensions.

The panel board 40 is a standard power distribution and control board or switchgear. It may be coupled to the busway 10, a utility meter device 42 and a power source 44. The utility meter device 42 meters the amount of the power expended by the EV charging system 1 during a given interval (e.g., hours, days, or months). The power source 44 may be a high capacity distribution transformer from the utility. It may be used for high current applications (e.g., without limitation, 1200 A-650 kA) such as power a large EV fleet.

The example embodiments of the EV charging system 1 according to the disclosed concept provide numerous benefits over the conventional EV charging systems for EV fleets. The conventional EV charging systems require traditional cable and/or conduit installation for wall mounted or pedestal EV chargers. Such cable and/or conduit installation requires running and wiring a large number (e.g., without limitation, 50) of sets of cables from the current protection devices and the panel boards. Each cable then needs to be wired for installation. By completely integrating the EV chargers 100 into the bus-plugs 20, the EV charging system 1 provides an easy plug & charge installation with no wiring or running of the cables and/or conduits around or within the walls or ground. That is, the installing of the EV chargers 100 requires simply plugging the bus-plugs 20 into the sockets 15 at desired tapping points of the busways 10 and locking the bus-plugs 20 at the desired tapping points. Thus, no wiring and/or running of the cables or conduits are required for the EV charging system 1. Further, the EV charging system 1 is both scalable and modular by connecting additional busways 10 to the existing busways 10 and simply plugging additional bus plugs 20 to the tapping points of the added busways 10. Further, the parking garage or lot itself can be expanded as the EV fleets grow by simply installing additional busways in the added parking spaces. Additionally, the EV charging system 1 can be easily reduced by unplugging and unlocking the bus-plugs 10 and/or removing excess busways 10. In addition, the bus plugs 20 can be easily swapped, replaced and/or relocated from one parking spot to another as needed. Moreover, by removing the EV chargers 100 from the wall or the ground and placing them near the ceiling or sufficiently above the EVs 400, the EV charging system 1 provides more spaces for the EVs 400 to be charged and prevents any accidents, damages or injuries that may result from running over the cables, conduits or the valuable EV chargers 100 by the EVs 400.

FIGS. 2A-B illustrate an exemplary bus-plug 20 with an EV charger 100 integrated therein in accordance with a non-limiting example embodiment of the disclosed concept. FIG. 2A illustrates a top view of the bus-plug 10 incorporating an EV charger 100 and a current protection device 21 with the power and communication lines 27,28 connected thereto. The bus-plug 20 includes a current protection device 21, an LED indication light 22, an E-stop field connection 23, an Ethernet port 24, an ON/OFF control 25, a locking mechanism 26, and a cable management system 29. The EV charger 100 is coupled to the EV cord 300 and the EV charging connector 200. FIG. 2B is a perspective view of the bus-plug 20 with the EV charger 100 incorporated therein. The EV charger 100 is coupled to the EV connector 200 via the EV cord 300. The EV connector 200 optionally includes a user verification component 210.

FIGS. 3 and 4 illustrate an exemplary bus-plug 20 with an integrated EV charger 100 plugged and locked into a tapping point (e.g., a portion of a busway 10 including a socket 15) of the busway 10 according to a non-limiting example embodiment of the disclosed concept. FIG. 3 is a perspective view of the bus-plug 20 with an integrated EV charger 100 plugged and locked into a tapping point (e.g., a portion of a busway 10 including a socket 15) of the busway 10 according to a non-limiting example embodiment of the disclosed concept. FIG. 4 is a front view of the bus-plug 20 with an integrated EV charger 100 plugged and locked into a tapping point (e.g., a portion of a busway 10 including a socket 15) of the busway 10 according to a non-limiting example embodiment of the disclosed concept.

FIGS. 5A-C illustrate an exemplary adapter 30 structured to fixedly attach an EV charger 100 onto an inner surface of the bus-plug 20 in accordance with a non-limiting example embodiment of the disclosed concept. FIG. 5A is a top perspective view of the adapter 30 including a plate 31, fixing components 32 and side brackets 34. FIG. 5B is an isometric view of the bus-plug 20 with the EV charger 100 affixed thereto. FIG. 5C is a perspective top view of the back of the bus-plug 20. The back of the bus-plug 20 includes a plurality of thru-holes and the EV charger 100 is affixed to the back of the bus-plug 20 via the plurality of the thru-holes of the bus-plug 20 and the fixing components 32 of the adapter 30.

FIG. 6 is a flow chart of a method 600 for charging an EV fleet in accordance with a non-limiting example embodiment of the disclosed concept.

At 610, an EV charging system is provided. The EV charging system includes a first busway connected to a power source. The first busway includes the first socket and a first busbar structured to carry current from the power source to the first socket, a first bus-plug that is structured to be plugged into the first socket and includes a first EV charger structured to charge a first EV of an EV fleet, and a first EV connector that is coupled to the first EV charger via a first EV cord and structured to be inserted into a power receptacle for the first EV.

At 620, the first EV connector is inserted to the power receptacle for the first EV.

At 630, the first EV charger charges the first EV via the first EV connector and the first EV cord.

Optionally, when the EV fleet grows, the method 600 ensures charging of all EVs in the growing fleet by expanding the EV charging system. The expansion includes additional steps of: connecting a second busway structured to be connected to the first busway and the power source, the second busway including a second socket and structured to carry current from the power source to the second socket; plugging a second bus-plug into the second socket, the second bus-plug including a second EV charger structured to charge the second EV; inserting a second EV connector to a power receptacle for the second EV, the second EV connector coupled to the second EV charger via a second EV cord; and charging, by the second EV charger, the second EV. As such, all EVs in the EV fleet can be charged simultaneously or at different times as needed.

Optionally, when an EV charger or any other components of a bus-plug needs to be repaired or replaced, the method 600 further includes steps of: removing one of the first bus-plug or the second bus-plug from respective busway; and charging an EV from remaining bus-plug that is plugged into respective socket.

Optionally, when a user desires to relocate a bus-plug or swap bus-plugs, the method 600 further includes steps of: relocating one of the first bus-plug or the second bus-plug to the second busway or first busway, respectively; and charging an EV from respective EV charger integrated in respective relocated bus-plug.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An electric vehicle (EV) charging system, comprising:
a first busway connected to a power source, the first busway including a first socket and a first busbar structured to carry current from the power source to the first socket;
a first bus-plug structured to be plugged into the first socket, the first bus-plug comprising a first EV charger structured to charge a first EV of an EV fleet; and
a first EV connector that is coupled to the first EV charger via a first EV cord and structured to be inserted into a power receptacle for the first EV.

2. The system of claim 1, wherein the EV charging system is implemented in a facility and the first busway is disposed on or in proximity to the ceiling of the facility.

3. The system of claim 1, wherein, upon adding a second EV to the EV fleet, the system further comprises:
a second busway structured to be connected to the first busway and the power source, the second busway including a second socket and a second busbar structured to carry current from the power source to the second socket;
a second bus-plug structured to be plugged into the second socket, the second bus-plug comprising a second EV charger structured to charge the second EV; and
a second EV connector that is coupled to the second EV charger via a second EV cord and structured to be inserted into a power receptacle for the second EV.

4. The system of claim 3, wherein the first bus-plug is relocated and plugged into the second socket of the second bus-way and/or the second bus-plug is relocated and plugged into the first socket of the first bus-way.

5. The system of claim 3, wherein the first bus-plug is replaced by the second bus-plug or a third bus-plug comprising a third EV charger coupled to a third EV connector via a third EV cord.

6. The system claim 1, further comprising:
an adapter structured to fixedly attach the first EV charger to the first bus-plug, the adapter comprising a plate and a plurality of fixing components via which the plate is affixed to the first EV charger and an inner surface of the back of the first bus-plug.

7. The system of claim 1, further comprising:
a cable management system coupled to the first EV cord and the first EV connector, the cable management system comprising a spring loaded mechanism structured to place the first EV cord and the first EV connector in a position accessible to a user for charging and away from the first EV and drive path of the first EV, allow the first EV cord to extend so as to enable the user to charge the first EV, and return the first EV cord and the first EV connector to the position upon releasing of the first EV connector by the user.

8. The system of claim 1, wherein the first bus-plug further comprises:
at least one of a current protection device, an LED indication light, an E-stop field connection, an Ethernet port and an ON/OFF control.

9. The system of claim 1, wherein the first bus-plug further comprises: a locking mechanism structured to fixedly attach the first bus-plug to the first busway.

10. The system of claim 1, wherein the first EV connector includes a user verification mechanism.

11. The system of claim 10, wherein the user verification mechanism is a QR code verifier.

12. A bus-plug for use in a busway for distributing power from a power source to a load, the bus-plug comprising:
an EV charger structured to charge an EV; and
an adapter structured to fixedly attach the EV charger to the bus-plug.

13. The bus-plug of claim 12, wherein the adapter comprises a plate and a plurality of fixing components via which the plate is affixed to the first EV charger and an inner surface of the back of the first bus-plug.

14. The bus-plug of claim 12, further comprising:
at least one of a current protection device, an LED indication light, an E-stop field connection, an Ethernet port and an ON/OFF control.

15. A method for charging an EV fleet, comprising:
providing an EV charging system that comprises a first busway connected to a power source, the first busway including a first socket and a first busbar structured to carry current from the power source to the first socket; a first bus-plug that is structured to be plugged into the first socket and comprises a first EV charger structured to charge a first EV of an EV fleet; and a first EV connector that is coupled to the first EV charger via a first EV cord and structured to be inserted into a power receptacle for the first EV;
inserting the first EV connector to the power receptacle for the first EV; and
charging, by the first EV charger, the first EV via the first EV connector and the first EV cord.

16. The method of claim 15, wherein the EV charging system is implemented in a facility and the first busway is disposed on or in proximity to the ceiling of the facility.

17. The method of claim 15, further comprising:
adding a second EV to the EV fleet;
connecting a second busway structured to be connected to the second busway and the power source, the second busway including a second socket and structured to carry current from the power source to the second socket;
plugging a second bus-plug into the second socket, the second bus-plug comprising a second EV charger structured to charge the second EV;
inserting a second EV connector to a power receptacle for the second EV, the second EV connector coupled to the second EV charger via a second EV cord; and
charging, by the second EV charger, the second EV.

18. The method of claim 17, further comprising:
removing one of the first bus-plug or the second bus-plug from respective busway; and
charging an EV from remaining bus-plug that is plugged into respective socket.

19. The method of claim 17, further comprising:
relocating the first bus-plug to the second busway or the second bus-plug to the first busway; and
charging an EV from respective EV charger integrated in respective relocated bus-plug.

20. The method of claim 15, wherein the EV charging system further comprises an adapter structured to fixedly attach the first EV charger to the first bus-plug, the adapter including a plate and a plurality of fixing components via which the plate is affixed to the first EV charger and an inner surface of the back of the first bus-plug.
